(19) United States
(12) Patent Application Publication
(10) Pub. No.: US 2004/0010416 A1
(43) Pub. Date: Jan. 15, 2004

(54) Arrangements for use in raising funds

(76) Inventor: Bradley W. Porzio, Pittsburgh, PA (US)

Correspondence Address: Brian Samuel Malkin, Ste. 310, 117 VIP Drive, Wexford, PA, 15090, US

(21) Appl. No.: 10/267,396

(22) Filed: Oct. 9, 2002

Related U.S. Application Data
(60) Provisional application No. 60/395,264, filed on Jul. 11, 2002.

(51) Int. Cl. G06F 17/60

(52) U.S. Cl. 705/1

(57) ABSTRACT

Arrangements for use in fundraising are disclosed. The present invention broadly contemplates the use of an apparatus for fundraising having a master portion and an additional member. The additional member may be detached from the master portion and is capable of attachment to a variety of different items.

Priority is claimed from the application Ser. No. 60/395,264 entitled “Business Method and Apparatus for Assisting Others to Raise Funds by Selling Discount Cards” filed on Jul. 11, 2002, and application Ser. No. __/___ entitled “Business Method and Apparatus for Assisting Others to Raise Funds by Selling Value Added Discount Cards” filed on Jul. 16, 2002.

### FIELD OF THE INVENTION

This invention relates to a system, method, and apparatus for fundraising, and, in particular, to the marketing and selling of fundraising cards to organizations that re-sell the cards to raise funds.

### BACKGROUND OF THE INVENTION

Assisting entities (hereinafter “fundraisers”) to raise funds through the sales of discount cards and coupons is a widely practiced and well-known profit-making business. Those practicing the business (hereinafter “fundraising facilitators”) locate interested institutions, typically, educational and charitable institutions, identify their needs, facilitate the printing of appropriate discount cards for the institution, and either sell them or give them to the institution. The discount cards are typically made of a rigid material, with two sides, and have printed on them coupons, offers, and discounts offered by vendors of goods or services (“participating vendors”). The name, address, telephone number, and web site (“identifying information”) and event schedules for the fundraisers (“schedule information”) typically will be printed on the cards.

The fundraisers either pay the fundraising facilitators for each card or for a percentage of the gross sales of the cards. Individuals typically present the cards to participating vendors multiple times throughout a closed period of time, usually 12 months. This increases the floor traffic for the participating restaurants and retailers. Thus, there is an incentive for the participating vendors to participate in the discount program and there is an incentive for individuals to purchase the discount cards that are being sold by a fundraiser. These incentives assure that the members and students of the fundraisers can easily sell the cards to persons in their local communities, and in the process, raise funds for their institutions.

Examples of other fundraising cards, methods and systems of raising funds through sales of such cards can be seen at www.thediscountcard.com, www.krazycard.com/thekrazykard.htm, and http://www.americansfundraising.com—all of which display cards with discount offers from local restaurants and retail entities. Advertising and coupon offers are arranged by either the fundraising facilitator or the fundraiser. The cards are purchased by fundraisers whose members re-sell the cards at a profit.

Among the problems with fundraising cards, however, is that some vendors of goods or services may not want to participate in a program that provides for continuous discounts with no way to track the number of times a particular card is presented to obtain a discount. Another problem is that until now a typical fundraising card has no redemption process and is only limited by the expiration date on the card. Thus, a need exists for an invention that allows a participating vendor to track the number of uses of the fundraising card and to provide a means for redemption of that vendor's coupon offer.

### BRIEF SUMMARY OF THE INVENTION

The present invention broadly contemplates a system, method and apparatus for use in fundraising. The apparatus for fundraising is a thin two-sided piece of rigid material with means for displaying advertisements, coupons, and identifying information. The apparatus includes one ore more additional members that may be detached from the master portion and is capable of attachment to a variety of different items. The system and method involves enlisting at least one participating vendor and selling multiple apparatus to raise funds.

In one embodiment, the invention is an apparatus for fundraising, comprising: : a master portion fabricated from a sheet of material with a thin core with opposing planar sides, with one opposing planar side of said master portion displaying identifying information about a fundraiser, and the other opposing planar side of said master portion displaying at least one coupon offer from at least one participating vendor, and at least one perforatably attached additional member comprising a sheet of material with a thin core with opposing planar sides, one opposing planar side of said additional member displaying at least one coupon offer from a at least one participating vendor, the other opposing planar side of said additional member displaying identifying information from the participating vendor extending the coupon offer on the opposing planar side of the additional member, with said additional member having at least one attachment point

In another embodiment, the invention comprises a system and method for fundraising wherein the steps comprise: securing agreement of at least one participating vendor whereby their coupons are displayed on at least one apparatus for fundraising comprising: a master portion fabricated from a sheet of material with a thin core with opposing planar sides, with one opposing planar side of said master portion displaying identifying information about a fundraiser, and the other opposing planar side of said master portion displaying at least one coupon offer from at least one participating vendor, said master portion having at least one perforatably attached additional member comprising a sheet of material with a thin core with opposing planar sides, one opposing planar side of said additional member displaying at least one coupon offer from a at least one participating vendor, the other opposing planar side of said additional member displaying identifying information from the participating vendor extending the coupon offer on the opposing planar side of the additional member, with said additional member having at least one attachment point, and distributing at least one apparatus for fundraising.

### BRIEF DESCRIPTION OF THE SEVERAL VIEWS OF THE DRAWING

The invention will further be described in connection with the accompanying drawings, in which:

FIG. 1a depicts the front of a fundraising card of the prior art.

FIG. 1b depicts the back of the fundraising card of the prior art.

FIG. 2a depicts one planar side of one embodiment of the fundraising apparatus of the invention.

FIG. 2b depicts one planar side of one embodiment of the fundraising apparatus of the invention.

FIG. 3a is a block diagram for the steps of one embodiment of the system and method described by the present invention.

FIG. 3b is a block diagram for the steps of one embodiment of the system and method described by the present invention.

FIG. 4a depicts one planar side of one embodiment of the fundraising apparatus of the invention.

FIG. 4b depicts one planar side of one embodiment of the fundraising apparatus of the invention.

FIG. 5a depicts one planar side of one embodiment of the fundraising apparatus of the invention.

FIG. 5b depicts one planar side of one embodiment of the fundraising apparatus of the invention.

FIG. 5c. depicts one planar side of one embodiment of the fundraising apparatus of the invention.

### DETAILED DESCRIPTION OF THE INVENTION

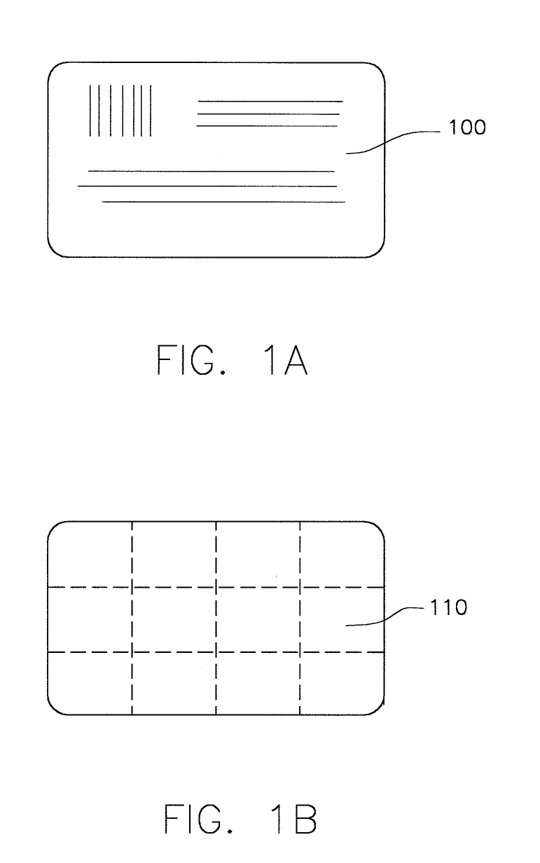

FIGS. 1a and 1b depict a typical fundraising card as made and sold in the prior art. The card is similar in size and shape to a standard credit card. It is fabricated out of any rigid material, including plastic or cardboard. It has a thin core with two opposing planar sides. One side of the fundraising card 100 is imprinted with information about the fundraising organization, including identification and event schedule. On the other side of the fundraising card 110 is printed coupons and advertising from various restaurants and local retail merchants. Among the problems with the typical fundraising card is that the user must remember or make room to place it in a wallet, purse, or pocket so it is available for use during the purchase.

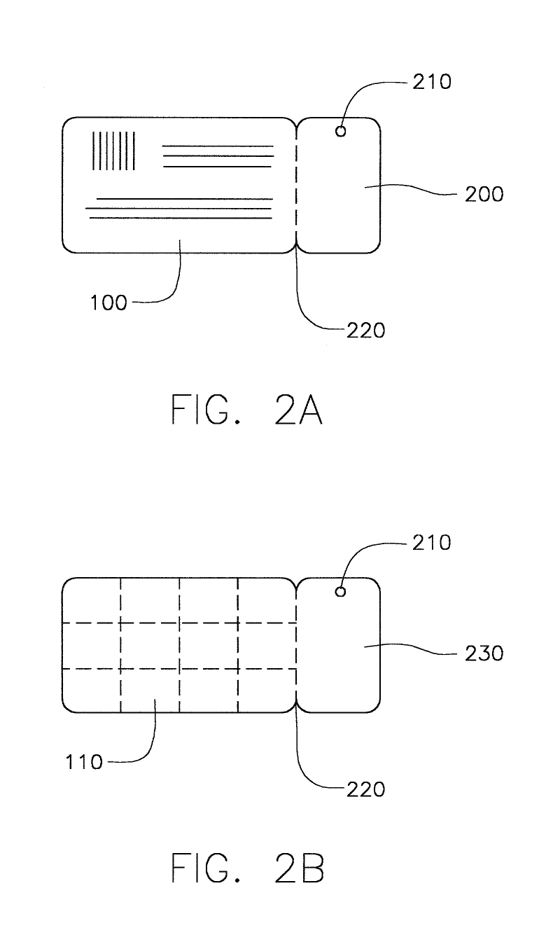

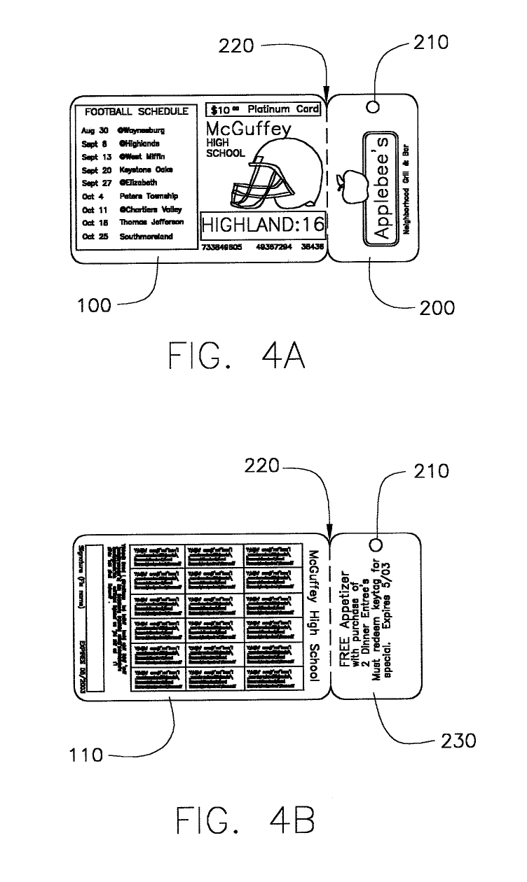

FIGS. 2a, 2b, 4a, 4b, 5a, 5b, and 5c depict the fundraising apparatus as described by the present invention. In one embodiment of the invention, on one planar side of the master portion of the apparatus 100 is displayed identifying information or schedule information or both for the fundraiser. On the other planar side of the master portion of the fundraising apparatus 110 is displayed advertising and coupon and discount offers from various participating vendors. The master portion has at least one attachment point allowing for attachment to a variety of items. It will be appreciated that multiple attachment points on the master portion may be used if desired.

Attached to the master portion of the fundraising apparatus is at least one perforatably-attached additional member 220. The additional member is preferably fabricated from the same material as the master portion of the fundraising apparatus, but any suitable material may be substituted as long as it has a thin core with two opposing planar sides suitable for displaying text. Preferably, both the master portion of the fundraising apparatus and the additional member are fabricated at the same time so as to minimize fabrication costs. It will be appreciated that any number of additional members are easily fabricated with the main card.

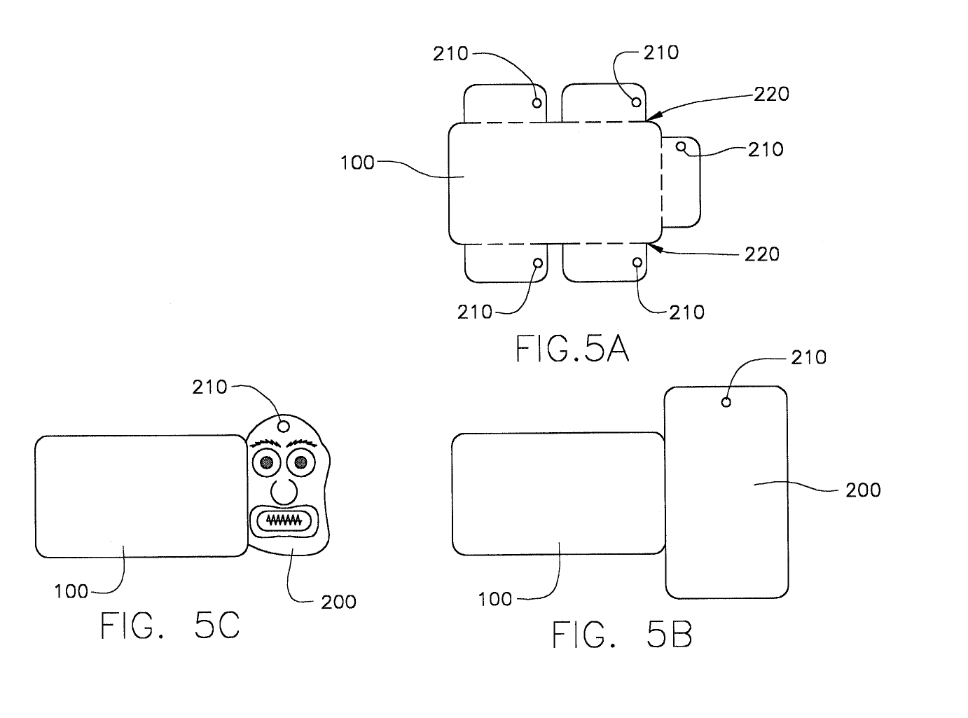

Both the master portion of the fundraising apparatus and the additional member may be any desired size and shape. FIG. 5b depicts a configuration whereby the master portion of the fundraising apparatus is approximately the same size as the additional member. Preferably the master portion of the fundraising apparatus will be a size that will fit in a wallet or pocket, but it could be larger or smaller. Additionally, both the master portion of the fundraising apparatus and the additional member could be any desired shape. FIG. 5c depicts a configuration whereby the additional member is an irregular shape such as a school mascot. The additional member could also be in the shape of a football or the numerals for the calendar year.

In a preferred embodiment of the invention, one planar side of the additional member displays identifying information and schedule information for the fundraiser. On the opposing planar side of the additional member is displayed advertising or coupon or discount offers from at least one participating vendor.

An additional member includes at least one attachment point 210 allowing the additional member to be attached by a variety of manners. For example, an additional member may be detached from the master portion of the fundraising apparatus and carried separately on a key ring and the problem of placing the fundraising apparatus in one's wallet, purse, or pocket is eliminated. Similarly, by means of a key ring, the additional member may be attached to a back pack. It may also be attached to a zipper. It may also be attached to a chain worn around the neck. It will be appreciated that these are just a few examples and all reasonable attachments are contemplated by this invention. Additionally, multiple attachment points on the additional member may be used if desired.

Another feature of the present invention is that the additional member 200 provides additional display space for at least one additional discount or coupon offer by a participating vendor. On one planar side of the additional member 230 is space for displaying identifying information and advertising for at least one participating vendor. The participating vendor may redeem the additional discount or coupon offer by taking it from the individual presenting it at the time of sale. Thus, the participating vendor need only count the number of additional members it has collected to determine the number of discounts given.

Additionally, since the additional member is typically attached to a key chain, the participating vendor's identifying information and advertising is more often exposed to public view. This additional public name exposure provides further incentive for the participating vendor to authorize a coupon discount on the additional member. Moreover, the additional discount offer is more appealing to the individual purchasers and this results in higher overall sales.

It will be appreciated that the planar sides of both the master portion and the additional member are capable of displaying any desired configuration of identifying information, schedule information, coupons, discount offers, and advertising. This invention contemplates all possible display configurations.

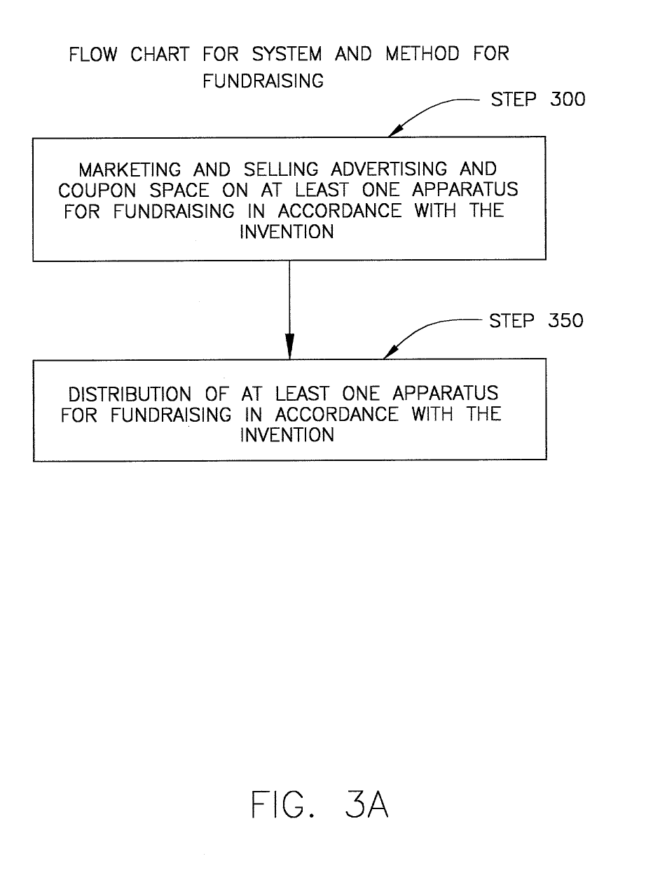

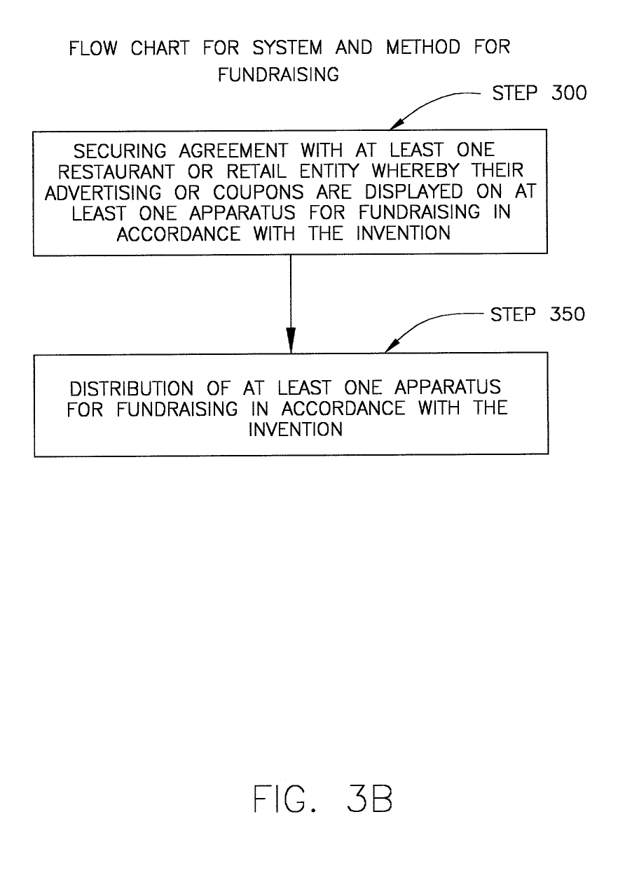

FIG. 3a and FIG. 3b set forth diagrams for the system and method described by the invention. At step 300, entities are solicited for their participation in the fundraising program. Solicitations may be accomplished through any appropriate manner, including: in person, on the telephone or through e-mail or direct mail. Entities may participate by means of advertising, coupons and discounts offered to those presenting the fundraising apparatus in accordance with the invention. It will be appreciated that the fundraising facilitator, the fundraiser, or a third party may perform the solicitations.

In one embodiment of the invention shown in FIG. 3a, entities solicited may pay for the display space on the fundraising apparatus. In another embodiment of the invention shown in FIG. 3b, to obtain maximum participation by vendors in the fundraising program, the display space is optimally given without payment. Since fundraisers are preferably charitable or educational entities, most entities will be pleased to lend their assistance by providing their coupons and discounts to presenters of the fundraising apparatus.

Finally, in Step 350, the fundraiser, though its members, students, or a third party, distributes at least one apparatus in accordance with the present invention.

It will be appreciated that to practice the system and method of this invention, step 300 and step 350 may be accomplished in any sequence. Further, the fundraiser may fabricate the fundraising apparatus using their own fabricating facilities or the fundraiser may hire a third party to fabricate the fundraising apparatus.

While a preferred form of the invention has been shown in the drawings and described, since variations in the preferred form will be apparent to those skilled in the art, the invention should not be construed as limited to the specific form shown and described, but instead is as set forth in the following claims.

What I claim as my invention is:

1. An apparatus suitable for fundraising, comprising:
a master portion fabricated from a
a sheet of material with a thin core with opposing planar sides,
with one opposing planar side of said master portion displaying identifying information about a fundraiser, and
the other opposing planar side of said master portion displaying at least one coupon offer from at least one participating vendor,
said master portion having at least one perforatably attached additional member
comprising a sheet of material with a thin core with opposing planar sides,
one opposing planar side of said additional member displaying at least one coupon offer from a at least one participating vendor,
the other opposing planar side of said additional member displaying identifying information from the participating vendor extending the coupon offer on the opposing planar side of the additional member,
with said additional member having at least one attachment point.

2. The apparatus of claim 1 wherein the master portion has at least one attachment point.

3. The apparatus of claim 1 wherein the attachment point of the additional member is capable of attachment to a key ring.

4. The apparatus of claim 1 wherein the attachment point of the additional member is capable of attachment to a chain.

5. The apparatus of claim 1 wherein the additional member is shaped like a school mascot.

6. The apparatus of claim 1 wherein the additional member is shaped like the last two digits of a calendar year.

7. The apparatus of claim 1 wherein said coupon offers expire within a set time period.

8. The apparatus of claim 1 wherein one planar side of the additional member displays schedule information for the fundraiser.

9. A system and method for fundraising with the steps comprising:
securing agreement of at least one participating vendor whereby their coupons are displayed on at least one apparatus for fundraising comprising:
a master portion fabricated from a
a sheet of material with a thin core with opposing planar sides,
with one opposing planar side of said master portion displaying identifying information about a fundraiser, and
the other opposing planar side of said master portion displaying at least one coupon offer from at least one participating vendor,
said master portion having at least one perforatably attached additional member
comprising a sheet of material with a thin core with opposing planar sides,
one opposing planar side of said additional member displaying at least one coupon offer from a at least one participating vendor,
the other opposing planar side of said additional member displaying identifying information from the participating vendor extending the coupon offer on the opposing planar side of the additional member,
with said additional member having at least one attachment point.
, and distributing at least one apparatus for fundraising.

10. The system and method of claim 8 wherein the participating vendor does not pay for the display space used for their coupon.

11. The system and method of claim 8 wherein the participating vendor pays for the display space for their coupon.

12. The system and method of claim 8 wherein the master portion of the apparatus has at least one attachment point.

13. The system and method of claim 8 wherein the attachment point of the additional member is capable of attachment to a key ring.

14. The system and method of claim 8 wherein the attachment point of the additional member is capable of attachment to a chain.

15. The system and method of claim 8 wherein the additional member is shaped like a school mascot.

16. The system and method of claim 8 wherein the additional member is shaped like the last two digits of a calendar year.

17. The system and method of claim 8 wherein said coupon offer expires within a set time period.

18. The system and method of claim 8 wherein one planar side of the additional member displays schedule information for the fundraiser.
